(19) United States
(12) Patent Application Publication
(10) Pub. No.: US 2009/0310072 A1
(43) Pub. Date: Dec. 17, 2009

(54) LIQUID CRYSTAL DISPLAY DEVICE AND METHOD OF MANUFACTURING THE SAME

(75) Inventors: Yasuhiro MORII, Tokyo (JP); Koji Yonemura, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: MITSUBISHI ELECTRIC CORPORTION, Tokyo (JP)

(21) Appl. No.: 12/481,744

(22) Filed: Jun. 10, 2009

(30) Foreign Application Priority Data
Jun. 11, 2008 (JP) 2008-152449

(51) Int. Cl. G02F 1/1337; G02F 1/1343

(52) U.S. Cl. 349/126; 349/187; 349/141

(57) ABSTRACT

A liquid crystal display device includes a gate line placed on an array substrate, a pixel electrode in a comb teeth shape, a common electrode in a comb teeth shape that generates an in-plane electric field with the pixel electrode, an alignment layer that has an alignment direction inclined at a predetermined rubbing angle β with respect to a vertical direction perpendicular to the gate line, and two sections (upper pixel and lower pixel) where a direction of response of liquid crystals is different. The comb teeth of the pixel electrode and the common electrode are inclined at a predetermined electrode angle α with respect to the vertical direction in each of the two sections, and the electrode angle α and the rubbing angle β satisfy conditions of |α|>|β| and 90°−|α−β|≧45° in each of the two sections.

### BACKGROUND OF THE INVENTION

1. Field of the Invention

The present invention relates to a liquid crystal display device and a method of manufacturing the same and, particularly, to an IPS mode liquid crystal display device and a method of manufacturing the same.

2. Description of Related Art

Watching moving images with a cellular phone becomes so common today that the term “One Seg” is widely used. Although general television images have a smaller number of horizontal partitions than the number of vertical partitions, a vertically oriented display is typically used in cellular phones. Therefore, there is often the case that a user rotates the vertically oriented display by 90° for use in the horizontal direction when watching moving images.

Further, a cellular phone is often used outdoors, and a user may watch images through polarized sunglasses. The absorption axis of the polarized sunglasses is oriented horizontally in order to prevent reflected light from entering the eyes. Accordingly, if transmitted light from a display screen of a cellular phone is in the horizontal direction, the polarized sunglasses absorb the light, and a user cannot view displayed images.

As described above, recent display devices are sometimes used by turning a display screen to vertical and horizontal positions while wearing polarized sunglasses. As a display device to be used in such a case, an In-Plane-Switching (IPS) mode liquid crystal display device may be used. The IPS mode of a liquid crystal display device uses a display technique that displays images by applying an in-plane electric field to liquid crystals filled between substrates placed opposite to each other. Typically, an in-plane electric field is generated by applying a voltage between two layers of metal electrodes having a comb teeth shape that are placed opposite to each other with an insulating layer interposed therebetween. The IPS mode liquid crystal display device is expected to meet the demand for high quality images, and various efforts have been made to improve the display quality and reduce costs.

One of the efforts is improvement of viewing angle characteristics. In the IPS mode liquid crystal display device, viewing angle characteristics are degraded due to a phenomenon called color shift that an image looks yellowish or bluish depending on the angle of view, tone reversal or the like. A method of improving viewing angle characteristics by suppressing the color shift or the tone reversal is disclosed in Japanese Unexamined Patent Publication No. 10-148826.

FIG. 8 is a plan view schematically showing the pixel structure of an IPS mode liquid crystal display device according to related art that is disclosed in Japanese Unexamined Patent Publication No. 10-148826. Referring to FIG. 8, a common electrode 3 and a pixel electrode 7 are placed in each pixel on a TFT array substrate. The common electrode 3 and the pixel electrode 7 are formed in a comb teeth shape and arranged in parallel with each other in each area surrounded by gate lines 43 and source lines 44. Each of the common electrode 3 and the pixel electrode 7 is formed to be bent like an elbow at a center part (bending point) as shown in FIG. 8.

Alignment layers are formed respectively on the TFT array substrate having the above structure and a counter substrate placed opposite to the TFT array substrate, and rubbing process is performed on the alignment layers in the direction perpendicular to the extending direction of the gate lines 43. Thus, when no voltage is applied, liquid crystal molecules 10 placed between the TFT array substrate and the counter substrate are oriented in the same direction as the rubbing direction. On the other hand, when a voltage is applied between the common electrode 3 and the pixel electrode 7, an in-plane electric field is generated in the direction orthogonal to the long side of the electrodes. Consequently, in the pixel area where the common electrode 3 and the pixel electrode 7 are placed, sections 47a and 47b in which the direction of a change in the orientation of liquid crystal molecules 11 is different are formed, so that the direction of the liquid crystal molecules 11 during driving is divided into two domains. It is thereby possible to improve the color shift due to optical anisotropy of the liquid crystal molecules 11 when displaying white in the IPS mode liquid crystal display device.

Because there are two domains, polarizing plates that are respectively placed on the outer side of the TFT array substrate and the counter substrate need to be placed with their absorption axes 15 arranged in parallel or perpendicularly to the extending direction of the gate lines 43. The two polarizing plates are placed orthogonal to each other in such a way that the respective absorption axes 15 are in crossed Nichols arrangement. In this structure, in the IPS mode liquid crystal display device, the polarization direction (optical axis) of transmitted light that is transmitted from a display screen is in parallel or perpendicular to the gate line 43. Thus, the transmitted light from the display screen is polarized in the horizontal or vertical direction.

Regarding this point, in display devices in which the direction of a display screen is fixed, it is possible to set the absorption axis 15 in the position to cope with polarized sunglasses in advance. However, in display devices in which a display screen is used in both vertical and horizontal positions such as recent cellular phones, the absorption axis 15 coincides with the absorption axis of polarized sunglasses in either position. As a result, when looking at an image through polarized sunglasses, display looks all black in either horizontal (landscape) or vertical (portrait) position.

In order to address the above concern, a technique of attaching a λ/4 plate on top of the polarizing plate is disclosed in Japanese Unexamined Patent Publication No. 10-10523. Further, a technique of attaching a polarization canceling plate that combines two quartz plates on top of the polarizing plate to thereby improve the visibility when looking at images through polarized sunglasses is disclosed in Japanese Unexamined Patent Publication No. 10-10522. Further, a technique of specifying the polarization direction of the polarizing plate on the display surface side to thereby improve the visibility when looking at images through polarized sunglasses is disclosed in Japanese Unexamined Patent Publication No. 10-49082.

However, because the techniques disclosed in Japanese Unexamined Patent Publications Nos. 10-10523 and 10-10522 require an additional member such as the λ/4 plate or the polarization canceling plate, the costs increase. Further, if such a member is attached to a liquid crystal display device, the thickness of the liquid crystal display device increases. On the other hand, if the technique disclosed in Japanese Unexamined Patent Publication No. 10-49082 is used in a typical IPS mode liquid crystal display device, the contrast decreases.

In light of the foregoing, it is desirable to provide an IPS mode liquid crystal display device with high display quality that enables a display to be viewed in both landscape and portrait positions through polarized sunglasses without need of any additional member, and a method of manufacturing the same.

### SUMMARY OF THE INVENTION

According to an embodiment of the present invention, there is provided a liquid crystal display device including liquid crystals filled between a first substrate having a thin film transistor and a second substrate placed opposite to the first substrate, which includes a gate line extending in a given direction on the first substrate and electrically connected to a gate electrode of the thin film transistor, a pixel electrode in a comb teeth shape electrically connected to a drain electrode of the thin film transistor, a common electrode in a comb teeth shape placed in a different layer from the pixel electrode with an insulating layer interposed therebetween so as to generate an in-plane electric field with the pixel electrode, an alignment layer placed on surfaces of the first substrate and the second substrate in contact with the liquid crystals and having an alignment direction inclined at a predetermined rubbing angle β with respect to a vertical direction perpendicular to the extending direction of the gate line, and two sections in a pixel area including the pixel electrode and the common electrode, a direction of response of the liquid crystals being different between the two sections when the in-plane electric field is generated, wherein comb teeth of the pixel electrode and the common electrode are inclined at a predetermined electrode angle α with respect to the vertical direction in each of the two sections, and the electrode angle α and the rubbing angle β satisfy conditions of |α|>|β| and 90°−|α−β|≧45° in each of the two sections.

According to another embodiment of the present invention, there is provided a method of manufacturing a liquid crystal display device including liquid crystals filled between a first substrate having a thin film transistor and a second substrate placed opposite to the first substrate, the method including steps of forming a gate line extending in a given direction and a common electrode in a comb teeth shape on the first substrate, forming a pixel electrode in a comb teeth shape electrically connected to a drain electrode of the thin film transistor and generating an in-plane electric field with the pixel electrode, and forming an alignment layer having an alignment direction inclined at a predetermined rubbing angle β with respect to a vertical direction perpendicular to the extending direction of the gate line on surfaces of the first substrate and the second substrate in contact with the liquid crystals, wherein the step of forming the common electrode, comb teeth of the common electrode is formed to be inclined in two different directions at a predetermined electrode angle α with respect to the vertical direction, and the electrode angle α and the rubbing angle β satisfy conditions of |α51 >|β| and 90°−|α−β|≧45° in each of the two directions.

According to the embodiments of the present invention, it is possible to provide an IPS mode liquid crystal display device with high display quality that enables a display to be viewed in both landscape and portrait positions through polarized sunglasses without need of any additional member, and a method of manufacturing the same.

The above and other objects, features and advantages of the present invention will become more fully understood from the detailed description given hereinbelow and the accompanying drawings which are given by way of illustration only, and thus are not to be considered as limiting the present invention.

### BRIEF DESCRIPTION OF THE DRAWINGS

FIG. 1 is a front view showing the structure of a TFT array substrate used in a liquid crystal display device;

FIG. 2 is a plan view schematically showing the pixel structure of a liquid crystal display device according to a first embodiment;

FIG. 3 is a view to describe an electrode angle α and a rubbing angle β;

FIG. 4 is a graph showing the relationship between a voltage and transmittance in an IPS mode liquid crystal display device with different effective rubbing angles;

FIG. 5 is a plan view schematically showing the pixel structure of a liquid crystal display device according to a second embodiment;

FIG. 6 is a plan view schematically showing the pixel structure of a liquid crystal display device according to a third embodiment;

FIG. 7 is a graph showing the relationship between a voltage and transmittance in an IPS mode liquid crystal display device with different cell gaps; and

FIG. 8 is a plan view schematically showing the pixel structure of an IPS mode liquid crystal display device according to related art.

### DESCRIPTION OF THE PREFERRED EMBODIMENTS

Preferred embodiments of the present invention will be described hereinbelow. The explanation provided hereinbelow merely illustrates exemplary embodiments of the present invention, and the present invention is not limited to the below-described embodiments. The following description and the accompanying drawings are appropriately shortened and simplified to clarify the explanation. Further, redundant explanation is omitted as appropriate to clarify the explanation. In the figures, the identical reference symbols denote identical elements and the explanation thereof is omitted as appropriate.

### First Embodiment

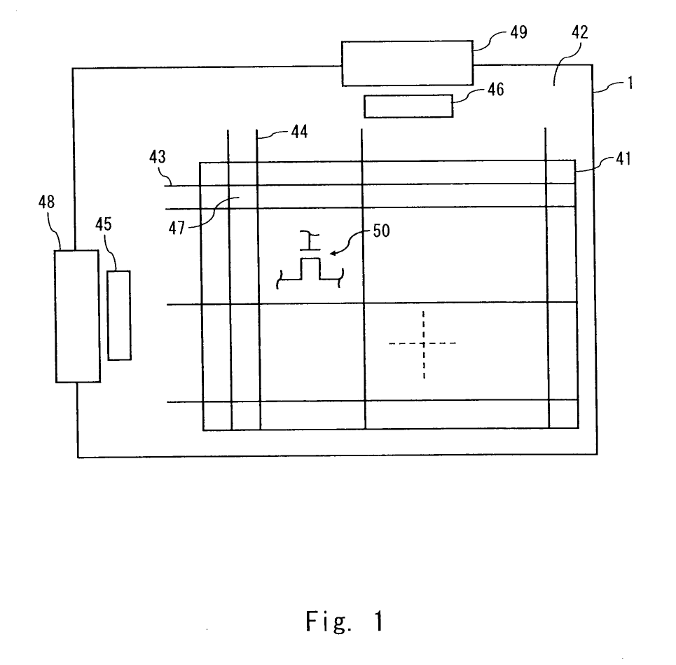

A liquid crystal display device according to an embodiment of the present invention is described hereinafter with reference to FIG. 1. FIG. 1 is a front view showing the structure of a thin film transistor (TFT) array substrate to be used in a liquid crystal display device. The liquid crystal display device according to the embodiment is an IPS mode liquid crystal display device in which a pixel electrode and a counter electrode are placed in the TFT array substrate. The overall structure of the liquid crystal display device is the same among the first to third embodiments described below.

The liquid crystal display device according to the embodiment includes a substrate 1. The substrate 1 is an array substrate such as a TFT array substrate, for example. The substrate 1 includes a display area 41 and a frame area 42 surrounding the display area 41. In the display area 41, a plurality of gate lines (scanning signal lines) 43 and a plurality of source lines (display signal lines) 44 are placed. The plurality of gate lines 43 are arranged in parallel with each other. The plurality of source lines 44 are also arranged in parallel with each other. The gate lines 43 and the source lines 44 intersect with each other. Further, a plurality of common lines (not shown) are placed in the display area 41. The plurality of common lines are arranged in parallel with each other. The common line is placed between the adjacent gate lines 43. The common lines and the gate lines are arranged substantially in parallel with each other. Each area surrounded by the adjacent gate lines 43 and the adjacent source lines 44 serves as a pixel 47. Thus, a plurality of pixels 47 are arranged in matrix in the substrate 1.

In the frame area 42 of the substrate 1, a scanning signal driving circuit 45 and a display signal driving circuit 46 are placed. The gate lines 43 extend from the display area 41 to the frame area 42 and are connected to the scanning signal driving circuit 45 at the end of the substrate 1. Likewise, the source lines 44 extend from the display area 41 to the frame area 42 and are connected to the display signal driving circuit 46 at the end of the substrate 1. An external line 48 is connected in the vicinity of the scanning signal driving circuit 45. Further, an external line 49 is connected in the vicinity of the display signal driving circuit 46. The external lines 48 and 49 are wiring boards such as a flexible printed circuit (FPS), for example.

External signals are supplied to the scanning signal driving circuit 45 and the display signal driving circuit 46 through the external lines 48 and 49. The scanning signal driving circuit 45 supplies a gate signal (scanning signal) to the gate lines 43 based on an external control signal. The gate lines 43 are sequentially selected by the gate signal. On the other hand, the display signal driving circuit 46 supplies a display signal to the source lines 44 based on an external control signal and display data. A display voltage according to display data is thereby supplied to each pixel 47.

Each pixel 47 includes at least one TFT 50. The TFT 50 is placed in the vicinity of the intersection of the source line 44 and the gate line 43. For example, the TFT 50 supplies a display voltage to a pixel electrode. Specifically, the TFT 50, which is a switching element, is turned on by the gate signal from the gate line 43. A display voltage is thereby applied from the source line 44 to the pixel electrode in a comb teeth shape that is connected to a drain electrode of the TFT 50. Further, the pixel electrode is placed opposite to a common electrode (counter electrode) in a comb teeth shape. An in-plane electric field corresponding to the display voltage is generated between the pixel electrode and the counter electrode. Further, an alignment layer (not shown) is placed on the surface of the substrate 1. The detailed structure of the pixel 47 is described later.

Further, a counter substrate is placed opposite to the substrate 1. The counter substrate is a color filter substrate, for example, and it is placed on the viewing side. On the counter substrate, a color filter, a black matrix (BM), an alignment layer and so on are placed. A liquid crystal layer is placed between the substrate land the counter substrate. In other words, liquid crystals are filled between the substrate 1 and the counter substrate. Further, a polarizing plate, a retardation film and so on are placed on the outer sides of the substrate 1 and the counter substrate. Furthermore, a backlight unit or the like is placed on the non-viewing side of the liquid crystal display panel.

The liquid crystals are driven by an in-plane electric field between the pixel electrode and the counter electrode. Specifically, the orientation of the liquid crystals between the substrates changes. The polarization state of light passing through the liquid crystal layer thereby changes. Specifically, the polarization state of linearly polarized light having passed through the polarizing plate changes by the liquid crystal layer. To be more precise, light from the backlight unit becomes linearly polarized light by the polarizing plate on the array substrate side. Then, the linearly polarized light passes through the liquid crystal layer, so that its polarization state changes.

The amount of light passing through the polarizing plate on the counter substrate side varies depending on the polarization state. Specifically, among the transmitted light that transmits through the liquid crystal display panel from the backlight unit, the amount of light passing through the polarizing plate on the viewing side varies. The orientation of liquid crystals varies depending on a display voltage to be applied. Therefore, it is possible to change the amount of light passing through the polarizing plate on the viewing side by controlling the display voltage. Thus, it is possible to display a desired image by varying the display voltage for each pixel.

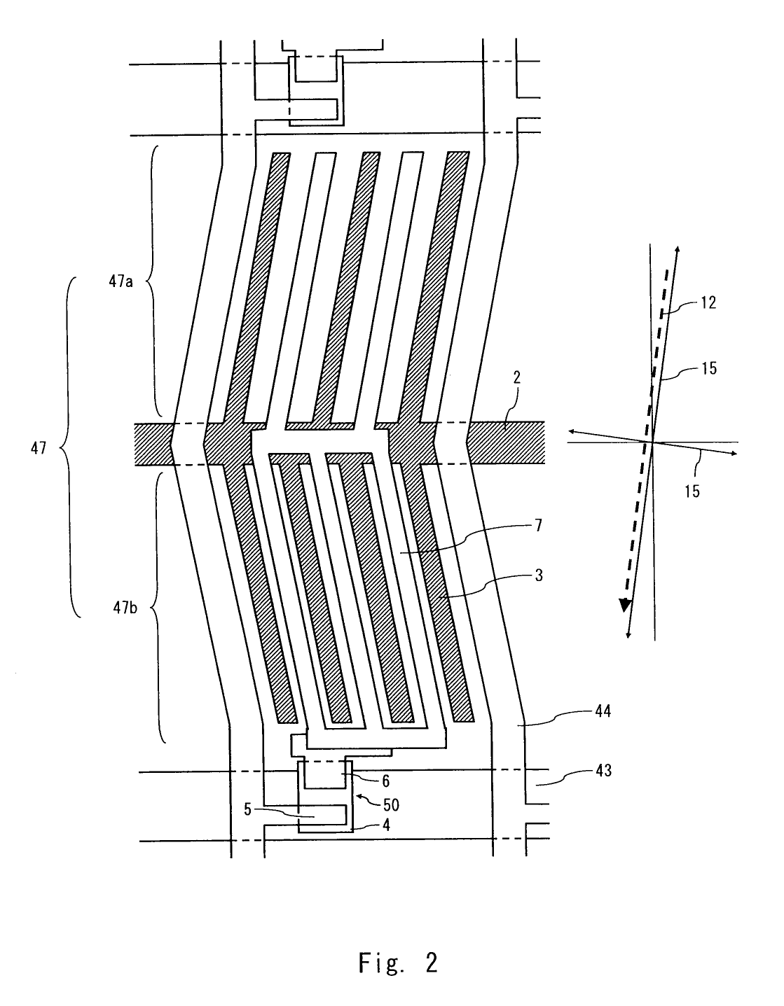

The pixel structure of the liquid crystal display device according to an embodiment of the present invention is described hereinafter with reference to FIG. 2. FIG. 2 is a plan view schematically showing the pixel structure of a liquid crystal display device according to a first embodiment. FIG. 2 shows one of the pixels 47 of the liquid crystal display device. The structure having the channel-etch type TFT 50 is described hereinbelow by way of illustration. FIG. 2 shows the structure on the array substrate side only.

Referring to FIG. 2, the gate line 43, a part of which serves as a gate electrode, is placed on the transparent insulating substrate 1 such as glass. The gate line 43 extends linearly in one direction on the substrate 1.

Further, on the substrate 1, a common line 2 is placed in the same layer as the gate line 43. The common line 2 is located separately from the gate line 43 and extends in parallel with the gate line 43. Thus, the common line 2 is arranged between the adjacent gate lines 43. A plurality of common lines 2 are included in the display area 41. The common line 2 is disposed in substantially the middle part of the pixel 47. Further, a plurality of common electrodes 3 extend from the common line 2, so that the common electrodes 3 are formed in a comb teeth shape. As shown in FIG. 2, the comb-teethed common electrodes 3 are inclined with respect to the direction perpendicular to the extending direction of the common line 2. Specifically, the comb-teeth parts of the common electrodes 3 are bent at the part of the common line 2 that is placed in substantially the middle of the pixel 47. The detail of the common electrodes 3 is described later.

The gate lines 43, the gate electrodes, the common lines 2 and the common electrodes 3 are made of Cr, Al, Ta, Ti, Mo, W, Ni, Cu, Au or Ag, an alloy film made mainly of those or a stacked film of those, for example.

Further, a gate insulating layer (not shown), which is a first insulating layer, is placed to cover the gate lines 43, the gate electrodes, the common lines 2 and the common electrodes 3. The gate insulating layer is made of an insulating film such as silicon nitride or silicon oxide. In the formation area of the TFT 50, a semiconductor layer 4 is placed opposite to the gate electrode with the gate insulating layer interposed therebetween. In this example, the semiconductor layer 4 is placed on the gate insulating layer so as to overlap the gate line 43, and the part of the gate line 43 which overlaps the semiconductor layer 4 serves as the gate electrode. The semiconductor layer 4 is made of amorphous silicon, polycrystalline polysilicon or the like, for example.

Further, ohmic contact layers into which conductive impurity is doped are placed on both ends of the semiconductor layer 4. The parts of the semiconductor layer 4 which correspond to the ohmic contact layers are source and drain regions, respectively. Specifically, the part of the semiconductor layer 4 which corresponds to the ohmic contact layer on the lower side in FIG. 2 serves as the source region. The part of the semiconductor layer 4 which corresponds to the ohmic contact layer on the upper side in FIG. 2 serves as the drain region. In this manner, the source and drain regions are formed at the both ends of the semiconductor layer 4. The part of the semiconductor layer 4 between the source and drain regions serves as a channel region. The ohmic contact layer is not placed on the channel region of the semiconductor layer 4. The ohmic contact layer is made of n-type amorphous silicon, n-type polycrystalline silicon or the like into which impurity such as phosphorus (P) is doped at high concentration, for example.

A source electrode 5 and a drain electrode 6 are respectively placed on the ohmic contact layers. Specifically, the source electrode 5 is placed on the ohmic contact layer on the source region side. The drain electrode 6 is placed on the ohmic contact layer on the drain region side. The channel-etch type TFT 50 is formed in this manner. The source electrode 5 and the drain electrode 6 extend to the outside of the channel region of the semiconductor layer 4. Thus, like the ohmic contact layers, the source electrode 5 and the drain electrode 6 are not placed on the channel region of the semiconductor layer 4.

The source electrode 5 extends to the outside of the channel region of the semiconductor layer 4 and is connected to the source line 44. The source line 44 is placed on the gate insulating layer and extends in the direction to intersect the gate line 43 over the substrate 1. Thus, the source line 44 branches off and extends along the gate line 43 at the intersection with the gate line 43, to form the source electrode 5. In this embodiment, the source line 44 is formed in the shape along the comb-teethed common electrode 3. Thus, the source line 44 is formed to be bent like an elbow between the adjacent gate lines 43. Therefore, in this embodiment, one pixel 47 that is defined by the area surrounded by the adjacent gate lines 43 and the adjacent source lines 44 has an elbow shape.

On the other hand, the drain electrode 6 extends to the outside of the channel region of the semiconductor layer 4. Thus, the drain electrode 6 has an extending part that extends to the outside of the TFT 50. The source electrode 5, the drain electrode 6 and the source line 44 are made of Cr, Al, Ta, Ti, Mo, W, Ni, Cu, Au or Ag, an alloy film made mainly of those or a stacked film of those, for example.

Further, an interlayer insulating layer (not shown), which is a second insulating layer, is placed to cover the source electrode 5, the drain electrode 6 and the source line 44. The interlayer insulating layer has a contact hole (not shown) that reaches the extending part of the drain electrode 6. The interlayer insulating layer is made of an insulating film such as silicon nitride or silicon oxide.

On the interlayer insulating layer, a pixel electrode 7 is placed in each pixel. The pixel electrode 7 is connected to the extending part of the drain electrode 6 through the contact hole of the interlayer insulating layer and electrically connected to the drain electrode 6. The pixel electrode 7 extends from the extending part of the drain electrode 6 to the inside of the pixel 47. Specifically, the pixel electrode 7 is made up of a plurality of electrodes that are arranged substantially in parallel and alternately with the plurality of common electrodes 3 and has a comb teeth shape as shown in FIG. 2. The pixel electrode 7 is made of a transparent conductive film such as ITO. The detail of the pixel electrode 7 is described later.

In the liquid crystal display device having the above structure, when a voltage is applied between the common electrode 3 and the pixel electrode 7, an in-plane electric field is generated in the direction orthogonal to the long side of those electrodes. The liquid crystal molecules 10 change their orientation by changing the direction so as to be aligned along the direction of the in-plane electric field. Accordingly, in the pixel area where the common electrodes 3 and the pixel electrodes 7 that are bent like an elbow are placed, sections in which the direction of a change in the orientation of the liquid crystal molecules 11 is different are formed.

In other words, one pixel 47 that is defined by the area surrounded by the adjacent gate lines 43 and the adjacent source lines 44 is divided into two sections, which are an upper pixel 47a and a lower pixel 47b, at a bending point of the elbow shape. In the upper pixel 47a and the lower pixel 47b, the direction in which the orientation of the liquid crystal molecules 11 changes is different from each other. Accordingly, the direction of the liquid crystal molecules 11 during driving is divided into two domains, and it is thereby possible to prevent the color shift due to optical anisotropy of the liquid crystal molecules 11 when displaying white in the IPS mode liquid crystal display device. Preferably, the upper pixel 47a and the lower pixel 47b are designed to have substantially the same area.

On the other hand, when no voltage is applied between the common electrode 3 and the pixel electrode 7, it is designed in this embodiment that the liquid crystal molecules 10 are oriented to be inclined with respect to the direction perpendicular to the extending direction of the gate line 43 (which is referred to hereinafter as the vertical direction). Specifically, the rubbing direction (alignment direction) 12 of the alignment layers formed respectively on the array substrate and the counter substrate is inclined with respect to the vertical direction. Therefore, the two polarizing plates placed respectively on the outside of the array substrate and the counter substrate are placed in parallel with or perpendicular to the rubbing direction 12 in such a way that their absorption axes 15 are in crossed Nichols arrangement. In this structure, the transmitted light from the display screen is polarized in the direction in parallel or perpendicular to the rubbing direction 12. Accordingly, the polarization direction of transmitted light that is transmitted from the liquid crystal display device does not completely coincide with the horizontal direction in which the absorption axis of polarized sunglasses is placed. It is thereby possible to prevent a display from looking all black in either horizontal (landscape) or vertical (portrait) position when looking at an image of a display device having a display screen that is used in both vertical and horizontal positions through polarized sunglasses. This enables a user to view a display in both landscape and portrait positions while wearing polarized sunglasses.

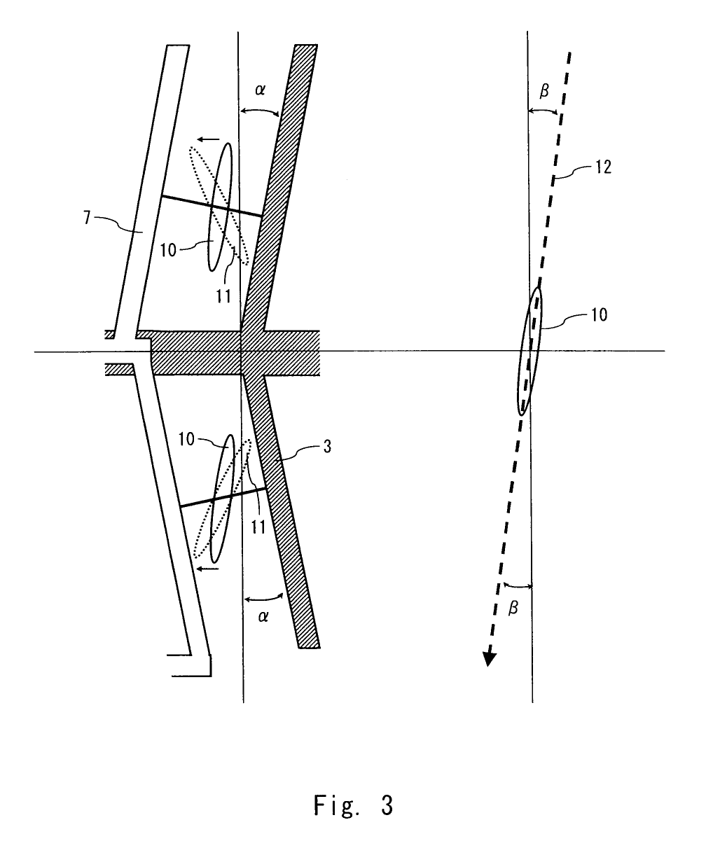

Referring to FIG. 3, the angle of inclination of the rubbing direction 12 with respect to the vertical direction (which is referred to hereinafter as the rubbing angle) is β. The angle of inclination of the common electrode 3 and the pixel electrode 7 with respect to the vertical direction (which is referred to hereinafter as the electrode angle) is α. In this embodiment, the relationship between the electrode angle α and the rubbing angle β is designed to satisfy the following expressions (1) and (2) in both sections of the upper pixel 47a and the lower pixel 47b:

|α|>|β| (1)

90°−|α−β|≧45°

The reason that the electrode angle α and the rubbing angle β are set as above is described hereinafter with reference to the following Table 1.

TABLE 1

| | | | | | | Angle to | |
|---|---|---|---|---|---|---|---|
| | | | | | | in-plane | |
| | | Electrode | Rubbing | Effective | | electric | |
| | Section | angle α | angle β | rubbing angle | | field | |
| Ref | Upper | 20° | 0° | 20° | | 70° | |
| | pixel | | | | | | |
| | Lower | −20° | 0° | −20° | | 70° | |
| | pixel | | | | | | |
| A | Upper | 20° | 15° | 5° | | 85° | |
| | pixel | | | | | | |
| | Lower | −20° | 15° | −35° | | 55° | |
| | pixel | | | | | | |
| B | Upper | 20° | 30° | −10° | ▾ | 80° | |
| | pixel | | | | | | |
| | Lower | −20° | 30° | −50° | ▾ | 40° | |
| | pixel | | | | | | |
| C | Upper | 5° | 30° | −25° | ▾ | 65° | |
| | pixel | | | | | | |
| | Lower | −5° | 30° | −35° | ▾ | 55° | |
| | pixel | | | | | | |
| D | Upper | 45° | 30° | 15° | | 75° | Δ |
| | pixel | | | | | | |
| | Lower | −45° | 30° | −75° | | 15° | Δ |
| | pixel | | | | | | |
| E | Upper | 33° | 30° | 3° | | 87° | Δ |
| | pixel | | | | | | |
| | Lower | −33° | 30° | −63° | | 27° | Δ |
| | pixel | | | | | | |
| F | Upper | −70° | 30° | −100° | | −10° | Δ |
| | pixel | | | | | | |
| | Lower | 40° | 30° | 10° | | 80° | Δ |
| | pixel | | | | | | |
| G | Upper | 30° | 15° | 15° | | 75° | |
| | pixel | | | | | | |
| | Lower | −30° | 15° | −45° | | 45° | |
| | pixel | | | | | | |

Table 1 is a correlation table for defining the electrode angle α and the rubbing angle β. In Table 1, the angle at which the common electrode 3 and the pixel electrode 7 are actually inclined with respect to the rubbing direction 12 is referred to as the effective rubbing angle. The effective rubbing angle is represented by an angle that is obtained by subtracting the rubbing angle β from the electrode angle α, which is α−β. Further, the maximum angle of rotation of the liquid crystal molecules 11 upon application of an in-plane electric field is referred to as the angle to in-plane electric field. The angle to in-plane electric field is represented by 90°−↑α−β|.

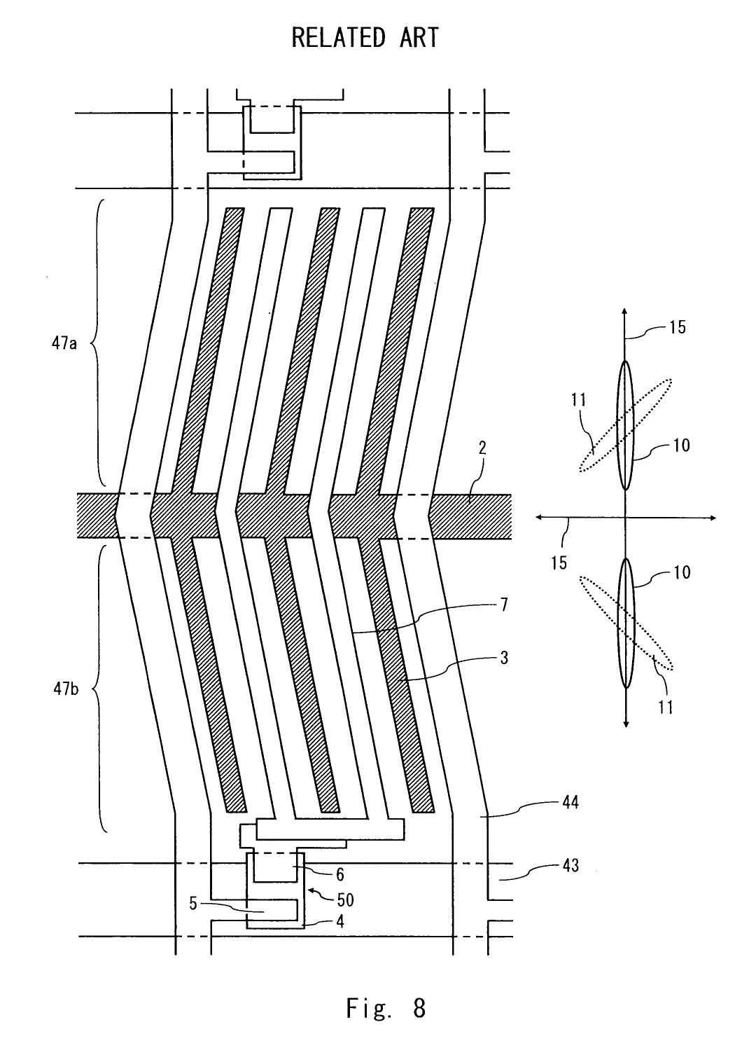

Table 1 shows the effective rubbing angle and the angle to in-plane electric field in seven cases A to G having different combinations of the electrode angle α and the rubbing angle β. Table 1 further shows those angles in the IPS mode liquid crystal display device according to related art shown in FIG. 8 as a reference (Ref).

First, the effective rubbing angle is discussed with reference to the case of the IPS mode liquid crystal display device according to related art shown in FIG. 8, which is Ref. In Ref, the electrode angle α in the upper pixel is 20° and the electrode angle α in the lower pixel is −20°, for example. Because no measure is taken for the absorption axis of polarized sunglasses, the rubbing angle β is 0° (or 90°). The effective rubbing angle of Ref in such conditions is 20° in the upper pixel and −20° in the lower pixel. This indicates that it is necessary for the effective rubbing angle to have an opposite sign (positive or negative) between the upper electrode and the lower electrode in order to allow the liquid crystal molecules 11 to respond in two directions. Referring to Table 1, in the cases B and C that have the mark ▾ in the field of the effective rubbing angle, the effective rubbing angle has the same sign in the upper electrode and the lower electrode, thus failing to allow the liquid crystal molecules 11 to respond in two directions. In the other cases A and D to G, the effective rubbing angle has an opposite sign in the upper electrode and the lower electrode as in Ref. Therefore, it is necessary to satisfy the expression (1) in order for the liquid crystal molecules 11 to respond in two directions.

Next, the angle to in-plane electric field is discussed. Generally in birefringent mode including the IPS mode, it is designed that the transmittance is maximum when a medium having refractive index anisotropy is oriented at an angle of 45° with respect to the absorption axis 15 of the polarizing plate. Thus, it is designed that the transmittance is minimum when the orientation of the liquid crystal molecules is at 0° and 90° with respect to the respective absorption axes 15 of the two polarizing plates in crossed Nichol arrangement and the transmittance is maximum when the orientation of the liquid crystal molecules is at 45° and 45°, thereby varying the amount of light.

Therefore, it is necessary that the liquid crystal molecules 11 rotate by at least 45° when an in-plane electric field is applied. Thus, the maximum angle of rotation of the liquid crystal molecules 11 upon application of an in-plane electric field, which is the angle to in-plane electric field, should be 45° or larger in both sections of the upper pixel 47a and the lower pixel 47b. Referring to Table 1, in the cases D to F that have the mark A in the field of the angle to in-plane electric field, the angle to in-plane electric field is smaller than 45° in at least one of the upper pixel and the lower pixel, thus failing to obtain the maximum birefringence effect. In the other cases A to C and G, the angle to in-plane electric field is 45° or larger as in Ref. Therefore, it is necessary to satisfy the expression (2) in order to obtain the maximum birefringence effect.

As described above, in this embodiment, the combination of the electrode angle α and the rubbing angle β that satisfies the expressions (1) and (2) in both sections of the upper pixel 47a and the lower pixel 47b is selected in order to allow the liquid crystal molecules 11 to respond in two directions and to obtain the maximum birefringence effect. Thus, in each of the plurality of sections where the direction of a change in the orientation of the liquid crystal molecules 11 is different, the comb teeth of the common electrodes 3 and the pixel electrode 7 are inclined with respect to the vertical direction at the electrode angle α that is larger than the rubbing angle β. Further, in each of the plurality of sections, the angle between the comb teeth of the common electrodes 3 and the pixel electrode 7 and the rubbing direction 12 is equal to or smaller than 45°. For example, if the electrode angle α in the upper pixel is 20°, the electrode angle α in the lower pixel is −20° and the rubbing angle β is 15° as shown in the case A of Table 1, it is possible to satisfy the expressions (1) and (2). As another example of the combination that satisfies the expressions (1) and (2), the electrode angle α in the upper pixel may be 30°, the electrode angle α in the lower pixel may be −30° and the rubbing angle β may be 15° as shown in the case G of Table 1.

The common electrode 3 and the pixel electrode 7 are inclined and bent like an elbow with respect to the direction perpendicular to the extending direction of the gate line 43 at the angle based on the selected electrode angle α described above in both sections of the upper pixel 47a and the lower pixel 47b. Further, in this embodiment, the spacing between the common electrode 3 and the pixel electrode 7 (which is referred to hereinafter as the electrode spacing) is different between the upper pixel 47a and the lower pixel 47b. Specifically, the electrode spacing is wider in the section where the angle between the inclination direction of the common electrode 3 and the pixel electrode 7 and the rubbing direction 12 is smaller, and the electrode spacing is narrower in the section where the above angle is larger. Thus, the common electrode 3 and the pixel electrode 7 in a comb teeth shape are placed opposite to each other with a wider spacing in either section of the upper pixel 47a or the lower pixel 47b where the effective rubbing angle is smaller compared to the other section where the effective rubbing angle is larger.

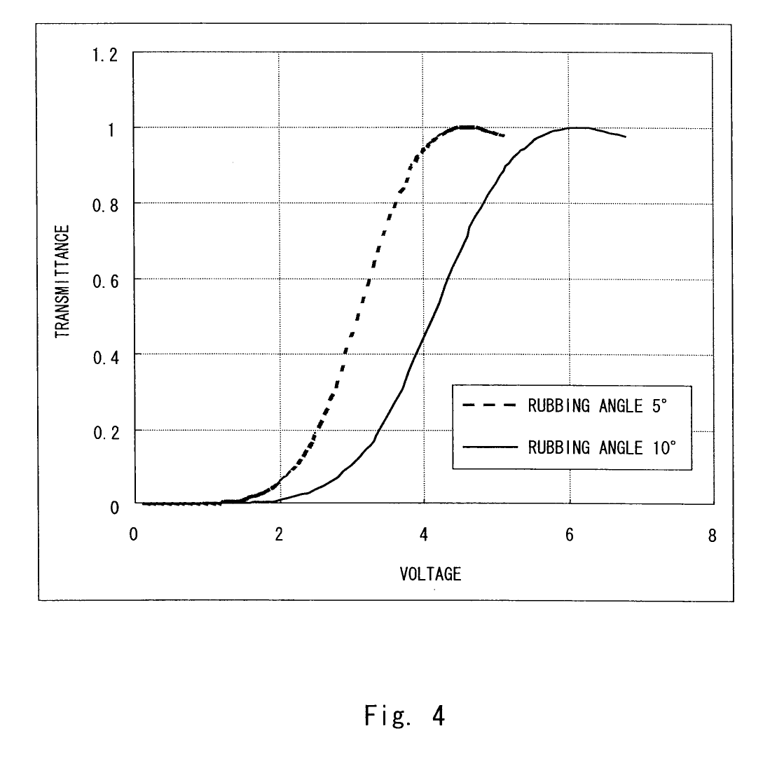

The reason that the upper pixel 47a and the lower pixel 47b have different electrode spacings is described hereinafter with reference to FIG. 4. FIG. 4 is a graph showing the relationship between a voltage and transmittance in the IPS mode liquid crystal display device having different effective rubbing angles. FIG. 4 shows two graphs with different effective rubbing angles. In FIG. 4, the graph when the effective rubbing angle is 5° is indicated by a dotted line, and the graph when the effective rubbing angle is 10° is indicated by a full line. FIG. 4 shows the case where the electrode spacing of the upper pixel 47a is equal to the electrode spacing of the lower pixel 47b.

It is obvious from FIG. 4 that a voltage necessary for obtaining the same transmittance is lower when the effective rubbing angle is 5° than when the effective rubbing angle is 10°. This is because, if the effective rubbing angle is small, the angle between the in-plane electric field generated between the common electrode 3 and the pixel electrode 7 and the dielectric anisotropy of the liquid crystal molecules is large, and it is thus possible to respond with a low voltage. On the other hand, if the effective rubbing angle is large, the angle between the in-plane electric field generated between the common electrode 3 and the pixel electrode 7 and the dielectric anisotropy of the liquid crystal molecules is small, and the equal transmittance cannot be obtained unless a higher voltage is applied. In this embodiment, because the effective rubbing angle is different between the upper pixel 47a and the lower pixel 47b, such a phenomenon occurs in one pixel. Specifically, the transmittance obtained when a certain voltage is applied to the pixel differs between the upper pixel 47a and the lower pixel 47b. Accordingly, an optical response is not uniform in one pixel, thus failing to obtain the uniform display characteristics.

If the electrode spacing in the section where the effective rubbing angle is larger is narrowed, it is possible to increase the strength of the in-plane electric field and thereby achieve characteristics in a lower voltage side. Thus, by setting the electrode spacing in the section with the larger effective rubbing angle to be narrower than the electrode spacing in the section with the smaller effective rubbing angle, it is possible to compensate a difference in optical response due to a difference in effective rubbing angle. The electrode spacing in the upper pixel 47a and the electrode spacing in the lower pixel 47b are set appropriately based on a difference in optical response due to a difference in effective rubbing angle. For example, in the case where the effective rubbing angles of the upper pixel 47a and the lower pixel 47b are 5° and 10°, respectively, the electrode spacings in the upper pixel 47a and the lower pixel 47b are adjusted so as to equate the characteristics of the full line and the characteristics of the dotted line shown in FIG. 4. As a result, the transmittance obtained when a given voltage is applied to the pixel does not differ between the upper pixel 47a and the lower pixel 47b, and it is possible to obtain the same dynamic characteristics in one pixel.

As described above, in this embodiment, the electrodes are arranged in such a way that the electrode spacing is different between the upper pixel 47a and the lower pixel 47b. Therefore, the comb-teeth-shaped common electrodes 3 extend from the common line 2 that is placed at the boundary between the upper pixel 47a and the lower pixel 47b. Further, the pixel electrode 7 is formed in such a way that the respective comb teeth are joined at the boundary as shown in FIG. 2. Thus, the origins of the comb teeth of the common electrodes 3 and the pixel electrode 7 are located at the boundary between the upper pixel 47a and the lower pixel 47b. In this arrangement, it is possible to change the spacing of comb teeth of the common electrodes 3 and the pixel electrode 7 at the boundary between the upper pixel 47a and the lower pixel 47b.

In the section with the smaller effective rubbing angle, the common electrode 3 and the pixel electrode 7 may have a smaller number of comb teeth than in the section with the larger effective rubbing angle. For example, in FIG. 2, three comb-teeth electrodes of the common electrodes 3 and two comb-teeth electrodes of the pixel electrode 7 are placed in the upper pixel 47a where the electrode spacing is wider. On the other hand, four comb-teeth electrodes of the common electrodes 3 and three comb-teeth electrodes of the pixel electrode 7 are placed in the lower pixel 47b where the electrode spacing is narrower.

Hereinafter, a method of manufacturing the liquid crystal display device according to an embodiment of the present invention is described. Firstly, a film made of Cr, Al, Ta, Ti, Mo, W, Ni, Cu, Au or Ag, an alloy film made mainly of those or a stacked film of those is deposited all over the transparent insulating substrate 1 such as glass. The film is formed all over the substrate 1 by sputtering or vapor deposition, for example. Next, a resist is applied thereon, and the applied resist is exposed to light through a photomask. The resist is then developed, thereby pattering the resist. This series of processes is referred to hereinafter as photolithography. After that, the film is etched using the resist pattern as a mask, thereby removing the photoresist pattern. The gate line 43, the gate electrode, the common line 2 and the common electrode 3 are thereby patterned. In this embodiment, the electrodes are formed in such a way that the spacing of the comb teeth of the common electrodes 3 extending from one side of the common line 2 is wider and the spacing of the comb teeth of the common electrodes 3 extending from the other side of the common line 2 is narrower. Further, the comb teeth of the common electrodes 3 are formed to be inclined and bent like an elbow with respect to the vertical direction perpendicular to the gate line 43 at the electrode angle α having the relationship with the rubbing angle β which satisfies the above expressions (1) and (2). In other words, the comb teeth of the common electrodes 3 are formed to be inclined in two different directions with respect to the vertical direction at the predetermined electrode angle α.

Next, a first insulating layer to serve as the gate insulating layer, a material of the semiconductor layer 4 and a material of the ohmic contact layer are deposited in this order so as to cover the gate line 43, the gate electrode, the common line 2 and the common electrode 3. They are formed all over the substrate 1 by plasma CVD, atmospheric pressure CVD, low pressure CVD or the like, for example. Silicon nitride, silicon oxide or the like may be used as the gate insulating layer. The material of the semiconductor layer 4 may be amorphous silicon, polycrystalline polysilicon or the like, for example. The material of the ohmic contact layer may be n-type amorphous silicon, n-type polycrystalline silicon or the like into which impurity such as phosphorus (P) is doped at high concentration, for example. After that, the layer to serve as the semiconductor layer 4 and the layer to serve as the ohmic contact layer are patterned into an island shape above the gate electrode by the process of photolithography, etching and resist removal.

Then, a film made of Cr, Al, Ta, Ti, Mo, W, Ni, Cu, Au or Ag, an alloy film made mainly of those or a stacked film of those is deposited to cover the layers formed above. The film is formed by sputtering or vapor deposition, for example. After that, the film is patterned by the process of photolithography, etching and resist removal, thereby forming the source electrode 5, the drain electrode 6 and the source line 44.

Then, the layer to serve as the ohmic contact layer is etched using the source electrode 5 and the drain electrode 6 as a mask. Specifically, the part of the ohmic contact layer having an island shape which is not covered with the source electrode 5 or the drain electrode 6 is removed by etching. The semiconductor layer 4 having the channel region between the source electrode 5 and the drain electrode 6 and the ohmic contact layer are thereby formed. Although the etching is performed using the source electrode 5 and the drain electrode 6 as a mask in this example, the etching of the ohmic contact layer may be performed using the resist pattern that is used when patterning the source electrode 5 and the drain electrode 6 as a mask. In this case, the ohmic contact layer is etched before removing the resist pattern on the source electrode 5 and the drain electrode 6.

After that, a second insulating layer to serve as the interlayer insulating layer is deposited to cover the source electrode 5, the drain electrode 6 and the source line 44. For example, an inorganic insulating film such as silicon nitride and silicon oxide is deposited as the interlayer insulating layer all over the substrate 1 by CVD or the like. The channel region of the semiconductor layer 4 is thereby covered with the interlayer insulating layer. After that, by the process of photolithography, etching and resist removal, a contact hole that reaches the extending part of the drain electrode 6 is made in the interlayer insulating layer.

Then, a transparent conductive film such as ITO is deposited on the interlayer insulating layer all over the substrate 1 by sputtering or the like. The transparent conductive film is then patterned by the process of photolithography, etching and resist removal. The pixel electrode 7 that is electrically connected to the drain electrode 6 through the contact hole and has a plurality of comb-teeth electrodes arranged substantially in parallel and alternately with the plurality of common electrodes 3 is thereby formed. In this embodiment, like the common electrode 3, the comb teeth of the pixel electrode 7 are formed to be inclined and bent like an elbow with respect to the vertical direction perpendicular to the gate line 43 at the electrode angle α having the relationship with the rubbing angle β which satisfies the above expressions (1) and (2). Further, the spacing of the comb teeth of the pixel electrode 7 is formed corresponding to the spacing of the comb teeth of the common electrodes 3, in such a way that the comb-teeth electrodes of the pixel electrode 7 are joined in the position opposite to the common line 2. By the processes described above, the array substrate according to the embodiment is completed.

On the array substrate fabricated as above, an alignment layer is formed by the subsequent cell manufacturing process. Further, an alignment layer is formed also on a counter substrate that is fabricated separately. Then, an alignment process (rubbing process) is performed on the respective alignment layers so as to make micro scratches in one direction on contact surfaces with liquid crystals. In this embodiment, the alignment process is performed in the rubbing direction 12 that is inclined with respect to the direction perpendicular to the gate line 43 at the rubbing angle β having the relationship with the electrode angle α which satisfies the above expressions (1) and (2). After that, a sealing material is applied to attach the array substrate and the counter substrate together. After attaching the array substrate and the counter substrate, liquid crystals are filled through a liquid crystal filling port by vacuum filling method or the like. The liquid crystal filling port is then sealed. Further, polarizing plates are attached to both sides of the liquid crystal cell that is formed in this manner. In this embodiment, two polarizing plates are placed in parallel with or perpendicular to the rubbing direction 12 in such a way that their absorption axes 15 are in crossed Nichol arrangement. Finally, driving circuits are connected, and a backlight unit is mounted. The liquid crystal display device according to the embodiment is thereby completed.

As described in the foregoing, in this embodiment, the comb teeth of the common electrode 3 and the pixel electrode 7 formed like an elbow and the rubbing direction 12 are inclined with respect to the direction perpendicular to the gate line 43 based on the electrode angle α and the rubbing angle β which satisfy the expressions (1) and (2). The absorption axis 15 of the polarizing plate can be thereby in the direction different from the horizontal direction along which the absorption axis of polarized sunglasses is placed in both landscape and portrait positions. It is thereby possible to prevent a display from looking all black in either landscape or portrait position when looking at the display of a display device having a display screen that is used in both vertical and horizontal positions through polarized sunglasses. Further, because the liquid crystal molecules 11 can respond in two directions and the birefringence effect can be obtained at maximum, it is possible to prevent the birefringence effect in one pixel 47 area from varying depending on the angle of view. Consequently, the color shift does not occur when viewed from different angles, and good viewing angle characteristics can be obtained. Further, there is no increase in thickness due to addition of a member unlike the techniques of Japanese Unexamined Patent Publications Nos. 10-10523 and 10-10522, thus allowing reduction in thickness of the liquid crystal display device. Furthermore, there is no decrease in contrast unlike when applying the technique of Japanese Unexamined Patent Publication No. 10-49082 to an IPS mode liquid crystal display device.

Further, in two sections in which the direction of response of the liquid crystal molecules 11 is different in one pixel 47, the spacing between the common electrode 3 and the pixel electrode 7 is wider in one section where the angle between the inclination direction of the common electrode 3 and the pixel electrode 7 and the rubbing direction 12 is smaller than in the other section where the above angle is larger. It is thereby possible to compensate a difference in optical response due to a difference in the angle between the inclination direction of the common electrode 3 and the pixel electrode 7 and the rubbing direction 12, thus achieving the same dynamic characteristics in one pixel. Therefore, in this embodiment, it is possible to provide an IPS mode liquid crystal display device with high display quality that enables a display to be viewed in both landscape and portrait positions through polarized sunglasses without need of any additional member, and a method of manufacturing the same.

### Second Embodiment

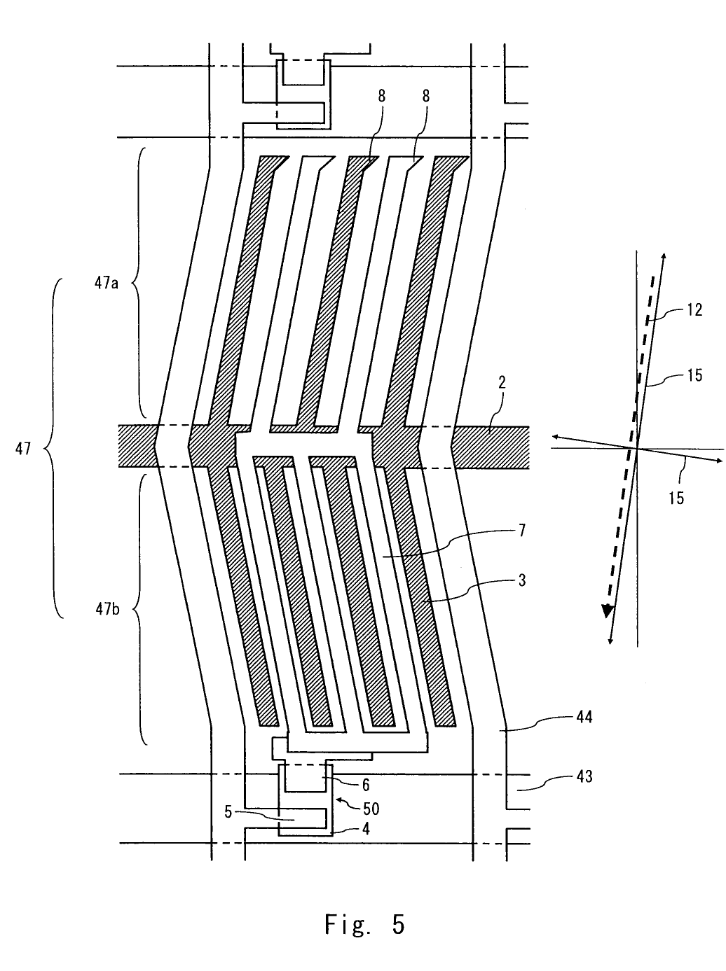

The pixel structure of a liquid crystal display device according to another embodiment of the present invention is described hereinafter with reference to FIG. 5. FIG. 5 is a plan view schematically showing the pixel structure of a liquid crystal display device according to a second embodiment. FIG. 5 shows one of the pixels 47 of the liquid crystal display device. FIG. 5 shows the structure on the array substrate side only. In this embodiment, the shape of the comb teeth of the common electrode 3 and the pixel electrode 7 in either one of the upper pixel 47a or the lower pixel 47b is different from that of the first embodiment. The other structure is the same as that of the first embodiment and thus not repeatedly described.

Referring to FIG. 5, in the section of either the upper pixel 47a or the lower pixel 47b which has the smaller effective rubbing angle, an extending part 8 for narrowing the electrode spacing is formed at the end of the comb teeth of the common electrodes 3 and the pixel electrode 7. The extending part 8 is placed in each comb-teeth electrode on the side where the angle between the extending direction of the gate line 43 and the comb teeth is smaller. By the extending part 8, the electrode spacing becomes narrow at the end of the comb teeth in one section where the angle between the inclination direction of the common electrode 3 and the pixel electrode 7 and the rubbing direction 12 is smaller out of the two sections in which the direction of response of the liquid crystal molecules 11 is different in one pixel 47. It is thereby possible to prevent that a disclination that occurs when applying a load is kept to cause a display defect. This is particularly effective when the angle between the inclination direction of the common electrode 3 and the pixel electrode 7 and the rubbing direction 12, which is the effective rubbing angle, is smaller than 15°.

The array substrate having such a structure may be manufactured by forming the comb-teeth electrodes each having the extending part 8 at the end in only one side of two sections in which the direction of response of the liquid crystal molecules 11 is different in the step of forming the common electrode 3 and the step of forming the pixel electrode 7 respectively. The other manufacturing method is the same as that of the first embodiment and thus not repeatedly described.

### Third Embodiment

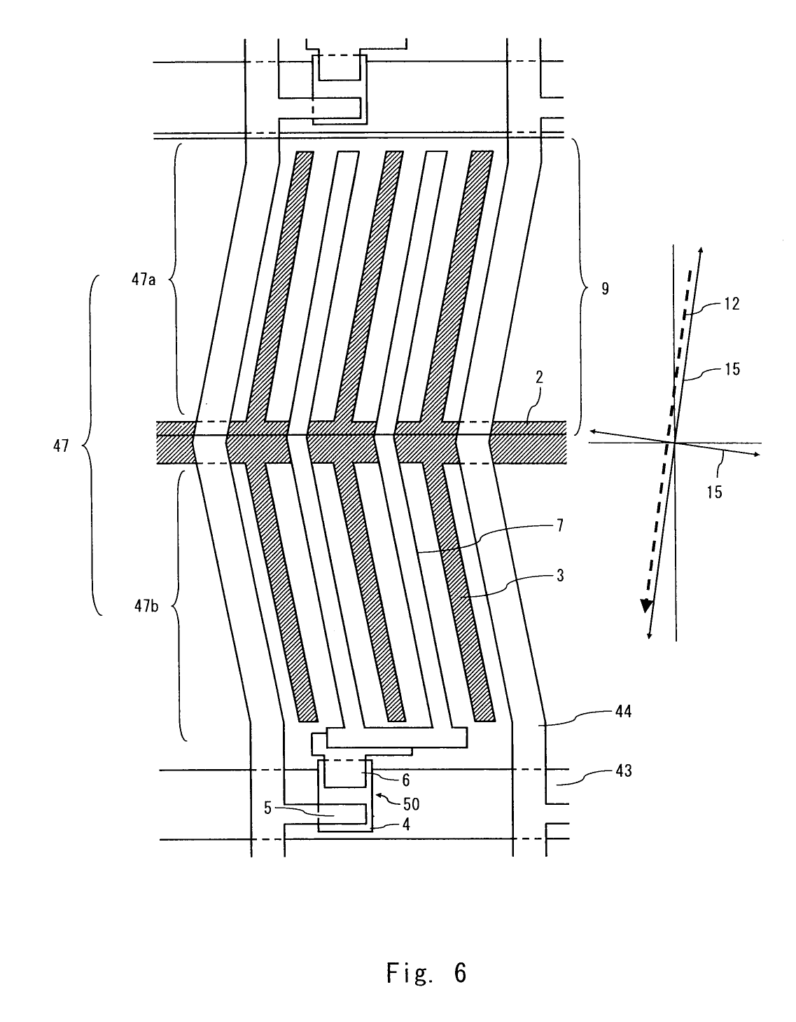

The pixel structure of a liquid crystal display device according to yet another embodiment of the present invention is described hereinafter with reference to FIG. 6. FIG. 6 is a plan view schematically showing the pixel structure of a liquid crystal display device according to a third embodiment. FIG. 6 shows one of the pixels 47 of the liquid crystal display device. FIG. 6 shows the structure on the array substrate side only. In the first embodiment, the electrode spacing between the common electrode 3 and the pixel electrode 7 is different between the upper pixel 47a and the lower pixel 47b. In this embodiment, the cell gap, instead of the electrode spacing, is different between the upper pixel 47a and the lower pixel 47b. The other structure is the same as that of the first embodiment and thus not repeatedly described.

Referring to FIG. 6, in the section of either the upper pixel 47a or the lower pixel 47b which has the smaller effective rubbing angle, a cell gap adjustment layer 9 is formed. The cell gap adjustment layer 9 is placed in at least one of the array substrate and the counter substrate. FIG. 6 shows the case where the cell gap adjustment layer 9 is placed in the upper pixel 47a on the array substrate by way of illustration. The cell gap thereby becomes narrower in the section having the smaller effective rubbing angle than in the section having the larger effective rubbing angle. In this embodiment, the electrode spacing is the same between the upper pixel 47a and the lower pixel 47b, which is different from the first embodiment. Therefore, the pixel electrode 7 is not necessarily formed in such a way that the respective comb teeth are joined at the boundary between the upper pixel 47a and the lower pixel 47b, and the comb-teeth electrodes may be joined in another part as shown in FIG. 6.

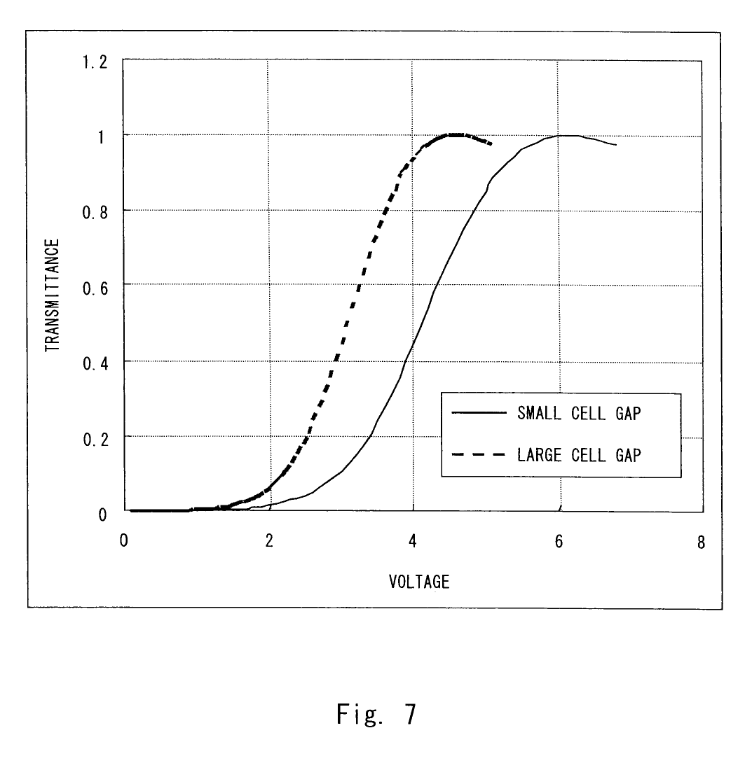

The reason that the upper pixel 47a and the lower pixel 47b have different cell gaps is described hereinafter with reference to FIG. 7. FIG. 7 is a graph showing the relationship between a voltage and transmittance in the IPS mode liquid crystal display device having different cell gaps. FIG. 7 shows two graphs with different cell gaps. In FIG. 7, the graph when the cell gap is wide is indicated by a dotted line, and the graph when the cell gap is narrow is indicated by a full line.

As explained in the first embodiment, a voltage necessary for obtaining the same transmittance is lower when the effective rubbing angle is small than when the effective rubbing angle is large. Accordingly, if the effective rubbing angle is small, it is possible to respond with a low voltage. On the other hand, if the effective rubbing angle is large, the equal transmittance cannot be obtained unless a higher voltage is applied. In this embodiment, because the effective rubbing angle is different between the upper pixel 47a and the lower pixel 47b, such a phenomenon occurs in one pixel. Specifically, the transmittance obtained when a certain voltage is applied to the pixel differs between the upper pixel 47a and the lower pixel 47b. Accordingly, an optical response is not uniform in one pixel, thus failing to obtain the uniform display characteristics.

If the cell gap in the section where the effective rubbing angle is smaller is narrowed, it is possible to achieve characteristics in a higher voltage side. It is obvious from FIG. 7 that a voltage necessary for obtaining the same transmittance is lower when the cell gap is wide than when the cell gap is narrow. Thus, by setting the cell gap in the section with the smaller effective rubbing angle to be narrower than the cell gap in the section with the larger effective rubbing angle, it is possible to compensate a difference in optical response due to a difference in effective rubbing angle. The cell gap in the upper pixel 47a and the cell gap in the lower pixel 47b are adjusted appropriately based on a difference in optical response due to a difference in effective rubbing angle. For example, in the case where the characteristics in the section with the smaller effective rubbing angle is the graph indicated by the dotted line of FIG. 7 and the characteristics in the section with the larger effective rubbing angle is the graph indicated by the full line of FIG. 7, for example, the cell gap adjustment layer 9 having the thickness that is adjusted so as to equate the characteristics of the full line and the characteristics of the dotted line shown in FIG. 7 is formed in the section with the smaller effective rubbing angle. As a result, the transmittance obtained when a given voltage is applied to the pixel does not differ between the upper pixel 47a and the lower pixel 47b, and it is possible to obtain the same dynamic characteristics in one pixel as in the first embodiment.

Although the cell gap adjustment layer 9 may be formed by adding a dedicated layer, it may be formed by using any of the layers constituting the array substrate or the counter substrate. A plurality of layers may be combined to form the cell gap adjustment layer 9. Further, the cell gap adjustment layer 9 may be placed on either one or both of the array substrate and the counter substrate.

Although the liquid crystal display device including the channel-etch type TFT 50 is described in the first to third embodiments, it may include another type of the TFT 50, such as a top-gate type. Further, although the case where the rubbing direction 12 is in the direction rotated rightward with respect to the vertical direction, which is in the direction where the sign of the rubbing direction 12 is positive, is described by way of illustration, the present invention is not limited thereto. For example, the rubbing direction 12 may be in the direction rotated leftward with respect to the vertical direction, which is in the direction where the sign of the rubbing direction 12 is negative.

The first to third embodiments may be combined as appropriate. For example, the second embodiment may be combined with the third embodiment. Further, the first embodiment may be combined with the third embodiment, so that the electrode spacing between the upper pixel 47a and the lower pixel 47b is different and further the cell gap adjustment layer 9 is formed.

From the invention thus described, it will be obvious that the embodiments of the invention may be varied in many ways. Such variations are not to be regarded as a departure from the spirit and scope of the invention, and all such modifications as would be obvious to one skilled in the art are intended for inclusion within the scope of the following claims.

What is claimed is:

1. A liquid crystal display device including liquid crystals filled between a first substrate having a thin film transistor and a second substrate placed opposite to the first substrate, comprising:
a gate line extending in a given direction on the first substrate and electrically connected to a gate electrode of the thin film transistor;
a pixel electrode in a comb teeth shape electrically connected to a drain electrode of the thin film transistor;
a common electrode in a comb teeth shape placed in a different layer from the pixel electrode with an insulating layer interposed therebetween so as to generate an in-plane electric field with the pixel electrode;
an alignment layer placed on surfaces of the first substrate and the second substrate in contact with the liquid crystals and having an alignment direction inclined at a predetermined rubbing angle β with respect to a vertical direction perpendicular to the extending direction of the gate line; and
two sections in a pixel area including the pixel electrode and the common electrode, a direction of response of the liquid crystals being different between the two sections when the in-plane electric field is generated, wherein
comb teeth of the pixel electrode and the common electrode are inclined at a predetermined electrode angle α with respect to the vertical direction in each of the two sections, and
the electrode angle α and the rubbing angle β satisfy conditions of |α|>|β| and 90°−|α−β|≧45° in each of the two sections.

2. The liquid crystal display device according to claim 1, wherein
an electrode spacing between the pixel electrode and the common electrode is different between the two sections.

3. The liquid crystal display device according to claim 2, wherein
the electrode spacing is wider in one of the two sections where an angle between the alignment direction of the alignment layer and the comb teeth of the pixel electrode and the common electrode is smaller than in the other one of the two sections where the angle is larger.

4. The liquid crystal display device according to claim 2, wherein
the pixel electrode and the common electrode are formed with the respective comb teeth being joined at a boundary between the two sections.

5. The liquid crystal display device according to claim 1, wherein
a cell gap between the first substrate and the second substrate is different between the two sections.

6. The liquid crystal display device according to claim 5, wherein
the cell gap is narrower in one of the two sections where an angle between the alignment direction of the alignment layer and the comb teeth of the pixel electrode and the common electrode is smaller than in the other one of the two sections where the angle is larger.

7. The liquid crystal display device according to claim 1, wherein
an extending part for narrowing an electrode spacing between the pixel electrode and the common electrode is placed at an end of the comb teeth of the pixel electrode and the common electrode in one of the two sections where an angle between the alignment direction of the alignment layer and the comb teeth of the pixel electrode and the common electrode is smaller.

8. A method of manufacturing a liquid crystal display device including liquid crystals filled between a first substrate having a thin film transistor and a second substrate placed opposite to the first substrate, the method comprising steps of:
forming a gate line extending in a given direction and a common electrode in a comb teeth shape on the first substrate;
forming a pixel electrode in a comb teeth shape electrically connected to a drain electrode of the thin film transistor and generating an in-plane electric field with the common electrode; and
forming an alignment layer having an alignment direction inclined at a predetermined rubbing angle β with respect to a vertical direction perpendicular to the extending direction of the gate line on surfaces of the first substrate and the second substrate in contact with the liquid crystals, wherein
in the step of forming the common electrode, comb teeth of the common electrode is formed to be inclined in two different directions at a predetermined electrode angle α with respect to the vertical direction, and
the electrode angle α and the rubbing angle β satisfy conditions of |α|>|β| and 90°−|α−β|>45° in each of the two directions.

9. The method of manufacturing the liquid crystal display device according to claim 8, wherein
an electrode spacing between the pixel electrode and the common electrode is different between the two directions.

10. The method of manufacturing the liquid crystal display device according to claim 9, wherein
the electrode spacing is wider in one of the two directions where an angle between the alignment direction of the alignment layer and the comb teeth of the pixel electrode and the common electrode is smaller than in the other one of the two directions where the angle is larger.

11. The method of manufacturing the liquid crystal display device according to claim 8, wherein
the pixel electrode and the common electrode are formed with the respective comb teeth being joined at a boundary between the two directions.

12. The method of manufacturing the liquid crystal display device according to claim 8, wherein
a cell gap between the first substrate and the second substrate is different between the two directions.

13. The method of manufacturing the liquid crystal display device according to claim 12, wherein
the cell gap is narrower in one of the two directions where an angle between the alignment direction of the alignment layer and the comb teeth of the pixel electrode and the common electrode is smaller than in the other one of the two directions where the angle is larger.

14. The method of manufacturing the liquid crystal display device according to claim 8, wherein
an extending part for narrowing an electrode spacing between the pixel electrode and the common electrode is placed at an end of the comb teeth of the pixel electrode and the common electrode in one of the two directions where an angle between the alignment direction of the alignment layer and the comb teeth of the pixel electrode and the common electrode is smaller.
